(19) United States
(12) Patent Application Publication
(10) Pub. No.: US 2024/0104900 A1
(43) Pub. Date: Mar. 28, 2024

(54) FISH SCHOOL DETECTION METHOD AND SYSTEM THEREOF, ELECTRONIC DEVICE AND STORAGE MEDIUM

(71) Applicant: Huzhou University, Huzhou (CN)

(72) Inventors: Wei Long, Huzhou (CN); Linhua Jiang, Huzhou (CN); Yawen Wang, Huzhou (CN); Yunliang Jiang, Huzhou (CN); Wenjun Hu, Huzhou (CN); Fei Yin, Huzhou (CN)

(21) Appl. No.: 18/454,811

(22) Filed: Aug. 24, 2023

(30) Foreign Application Priority Data
Sep. 16, 2022 (CN) 2022111318722

(51) Int. Cl. G06V 10/77; G06V 10/80

(52) U.S. Cl. CPC G06V 10/7715; G06V 10/806

(57) ABSTRACT

A fish school detection method and a system thereof, an electronic device and a storage medium are provided, the method includes inputting a to-be-detected fish school image into a fish school detection model; the fish school detection model including a feature extraction layer, a feature fusion layer and a feature recognition layer; extracting feature information of the to-be-detected fish school image based on the feature extraction layer, and determining a fish school feature map and an attention feature map based on an attention mechanism; fusing the fish school feature map and the attention feature map based on the feature fusion layer to determine a target fusion feature map; and determining a target fish school detection result based on the feature recognition layer and the target fusion feature map. Interference from environmental factors on detection results is eliminated, so as to effectively improve accuracy of the fish detection.

### TECHNICAL FIELD

The disclosure relates to the field of target detection technologies, and more particularly to a fish school detection method and a system thereof, an electronic device and a storage medium.

### BACKGROUND

Fish school detection has a great application value in detecting activity patterns of fish schools in lakes and oceans, analyzing sizes and types of fish schools. Moreover, a detection of fish density is a key link for good production management in aquaculture production.

At present, existing fish school detection methods include sensor detection, digital image processing method and deep learning object detection. The sensor detection is mainly based on sound and light sensors, and detection results are easily affected by noise, water quality, and light interference. The digital image processing method uses traditional visual algorithms to extract features and manual experience is combined to determine the detection results, resulting in low detection accuracy. Due to factors such as usually small size of fish datasets and complex fish features, existing deep learning object detection methods have problems such as low recognition accuracy and slow detection speed.

The disclosure provides a fish school detection method and a system thereof, an electronic device and a storage medium, interference from environmental factors on detection results is eliminated, so as to effectively improve accuracy of the fish detection.

### SUMMARY

The disclosure provides a fish school detection method, the method includes: inputting a to-be-detected fish school image into a fish school detection model, the fish school detection model including: a feature extraction layer, a feature fusion layer and a feature recognition layer; extracting feature information of the to-be-detected fish school image to determine a fish school feature map and an attention feature map based on the feature extraction layer; fusing the fish school feature map and the attention feature map based on the feature fusion layer to determine a target fusion feature map; and determining a target fish school detection result based on the feature recognition layer and the target fusion feature map.

The disclosure provides a fish school detection system, the system includes: an image input unit, a feature extraction unit, a feature fusion unit and a feature recognition unit. The image input unit is configured to input a to-be-detected fish school image into a fish school detection model; the fish school detection model includes: a feature extraction layer, a feature fusion layer and a feature recognition layer. The feature extraction unit is configured to extract feature information of the to-be-detected fish school image to determine a fish school feature map and an attention feature map based on the feature extraction layer. The feature fusion unit is configured to fuse the fish school feature map and the attention feature map to determine a target fusion feature map based on the feature fusion layer. And the feature recognition unit is configured to determine a target fish school detection result based on the feature recognition layer and the target fusion feature map.

In an embodiment, each of the image input unit, the feature extraction unit, the feature fusion unit and the feature recognition unit are embodied by software stored in at least one memory and executable by at least one processor.

The disclosure provides an electronic device, the electronic device includes a memory, a processor, a computer program stored in the memory and executable on the processor, the processor is configured to execute the computer program to implement steps of the above fish school detection method.

The disclosure provides a non-transitory computer-readable storage medium, and the non-transitory computer-readable storage medium stores a computer program, and the computer program is configured to be executed by a processor to implement steps of the above fish school detection method.

### BRIEF DESCRIPTION OF DRAWINGS

In order to provide a clearer explanation of technical solutions in the disclosure or related art, drawings required in embodiments or the related art descriptions will be introduced below.

FIG. 1 illustrates a flowchart of a fish school detection method according to an embodiment of the disclosure.

FIG. 2 illustrates a structural schematic diagram of a fish school detection model according to an embodiment of the disclosure.

FIG. 3 illustrates a structural schematic diagram of a you only look once (YOLOv5s) algorithm network according to an embodiment of the disclosure.

FIG. 4 illustrates a structural schematic diagram of a fish school detection system according to an embodiment of the disclosure.

FIG. 5 illustrates a structural schematic diagram of an electronic device according to an embodiment of the disclosure.

### DETAILED DESCRIPTION OF EMBODIMENTS

Based on embodiments in the disclosure, all other embodiments obtained by those skilled in the art without creative labor fall within the scope of protection of the disclosure.

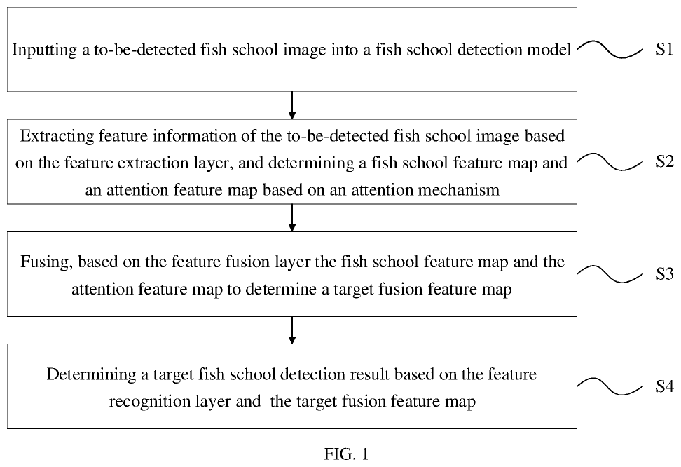

A flowchart of a fish school detection method provided in the disclosure is shown in FIG. 1, the embodiments of the disclosure provide a fish school detection method, the fish school detection method includes:

step S1: inputting a to-be-detected fish school image into a fish school detection model; and the fish school detection model includes: a feature extraction layer, a feature fusion layer and a feature recognition layer;

step S2: extracting feature information of the to-be-detected fish school image based on the feature extraction layer, and determining a fish school feature map and an attention feature map based on an attention mechanism;

step S3: fusing, based on the feature fusion layer, the fish school feature map and the attention feature map to determine a target fusion feature map; and

step S4: determining a target fish school detection result based on the feature recognition layer and the target fusion feature map.

In an exemplary embodiment, the target fish school detection result can be applied to analyze a fish activity, diagnose a fish disease to obtain a fish disease diagnosis result including a health condition, and analyze a fish feeding behavior, to thereby perform a fish production management, for example, the people can adjust a breeding strategy based on the fish activity and the health condition, such as adjusting a feeding time and a food species; the people can adjust a breeding environment based on the fish disease diagnosis result, such as adding oxygen, adjusting a water temperature and quality, changing water, and killing algae; and the people can adjust a feed dosage and the feeding time based on the fish feeding behavior.

It is necessary to obtain fish school images of target to-be-detected fish schools before conducting fish school detection. Sources of the to-be-detected fish school images, and types and amounts of the target fish schools are not limited.

Moreover, obtaining methods of the fish school images are not defined in the disclosure.

The target to-be-detected fish school image is obtained before inputting the to-be-detected fish school image into the trained fish school detection model in the step S1.

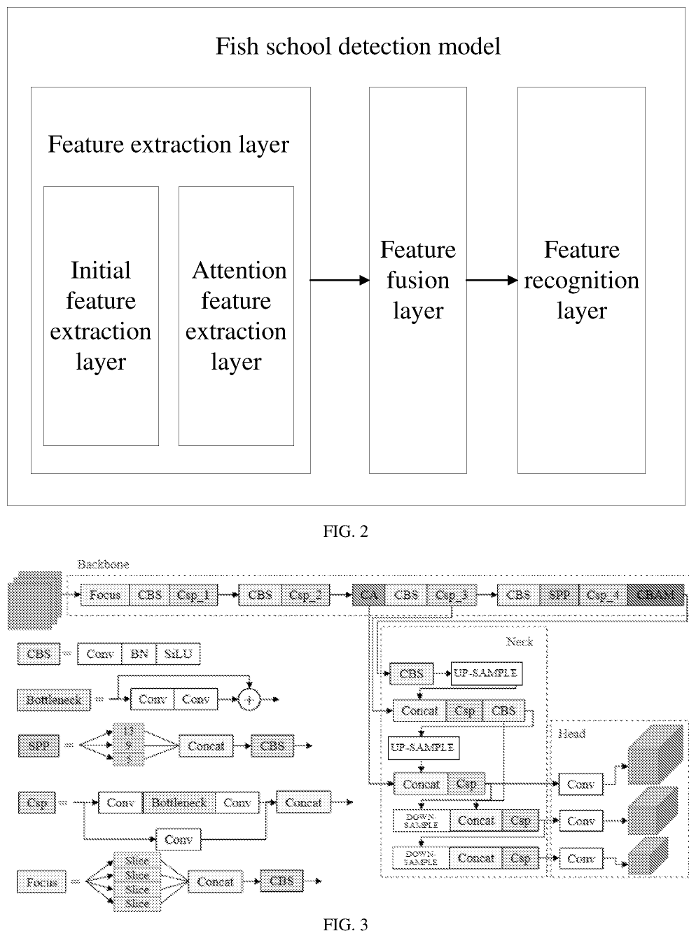

A structural schematic diagram of a fish school detection model provided in the disclosure is shown in FIG. 2, the fish school detection model includes: the feature extraction layer, the feature fusion layer and the feature recognition layer. A specific structure of the fish school detection model, recognition algorithms adopted by the model, and training methods of the model can be adjusted according to actual needs, and the disclosure does not define them.

In the step S2, the feature information of the to-be-detected fish school image is extracted based on the feature extraction layer to obtain the fish school feature map, and the attention feature map is obtained based on the attention mechanism.

During actual use of the disclosure, types of the attention mechanism can be selected according to actual needs, the disclosure does not define it.

The fish school feature map and the attention feature map are determined, then input into the feature fusion layer of the model, in the step S3, the fish school feature map and the attention feature map are fused based on the feature fusion layer to determine the target fusion feature map.

During actual use of the disclosure, a specific method of the feature fusion can be selected according to actual needs, the disclosure does not define it.

The fused target feature fusion map is input in to the feature recognition layer, in the step S4, the target fish school detection result is determined based on the feature recognition layer and the target fusion feature map.

During actual use of the disclosure, a specific target fish school detection result can be adjusted according to actual needs, the disclosure does not define it.

As shown in FIG. 2, when determining the attention feature map, the fish school feature map is input into a coordinate attention feature extraction layer, the fish school feature map is transformed to determine a coordinate attention feature map based on the coordinate attention feature extraction layer and a coordinate attention mechanism.

Then the coordinate attention feature map is input into a convolutional block attention feature extraction layer, the fish school feature map is transformed to determine a channel attention feature map based on the convolutional block attention feature extraction layer and a channel attention mechanism, and the channel attention feature map is transformed based on a spatial attention mechanism to determine a spatiotemporal attention feature map.

The fish school features are divided into individual features and overall features, and the individual features include a shape, a size, a form, a color, a texture and other features, the overall features include aggregation degree of fish schools, movement direction and position information.

The coordinate attention mainly extracts position information of targets, global feature dependencies are extracted to provide assistance for subsequent extraction of key fish school features. The spatiotemporal attention is divided in to the channel attention and the spatial attention, local features are extracted, and the overall features of the fish school can be extracted over a period of time. The spatiotemporal attention features are extracted to enhance effective features based on the global coordinate attention.

A structural schematic diagram of a you only look once (YOLOv5s) algorithm network provided in the disclosure is shown in FIG. 3, the model is improved based on the YOLOv5s algorithm network structure, a coordinate attention module and a convolutional block attention module are sequentially embedded in a backbone feature extraction network.

The specific structure of the fish school detection model in practical application of the disclosure is in conjunction to explain the disclosure. The fish school detection model includes: a backbone feature extraction network, a neck structure and a head structure.

The backbone feature extraction network is configured to extract features, and output three effective feature maps (i.e., the fish school feature map, the coordinate attention feature map and the spatiotemporal attention feature map).

For example, a coordinate attention (CA) module is added after a cross-stage-partial (Csp)_2 layer of backbone structure, the input fish school feature map Csp_2_F (80*80*128) is performed global average pooling based on its width or height to remain spatial structure information to obtain a first feature map, and a second feature map (80*1*128) and a third feature map (1*80*128) are obtained by performing a pair of one-dimensional feature encoding on the first feature map, the second feature map and the third feature map are connected to obtain a connected feature map of coexisting channel and spatial information, and a series of transformation are performed on the connected feature map to obtain a transformed fish school feature map f^{(h+w)} The formulas are as follows.

$${z}_{C}^{h} = \frac{1}{W} {\sum }_{0 \leq i \leq w} Csp\_ 2 {\_F}_{c} ( h , i ) \qquad ( 1 )$$

$${z}_{C}^{w} = \frac{1}{H} {\sum }_{0 \leq j \leq H} Csp\_ 2 {\_F}_{c} ( j , w ) \qquad ( 2 )$$

$${f}^{( h + w )} = \partial ( Csp\_ 2 {\_F}^{1 x 1} ( c a t ( ( {z}_{C}^{h} , {z}_{C}^{w} ) ) ) \qquad ( 3 )$$

The transformed fish school feature map f^{(h+w)} is performed segmentation based on width or height to obtain a fourth feature map f^{h} and a fifth feature map f^{w}, the fourth feature map f^{h} and the fifth feature map f^{w} are performed dimension elevation operation to output a first operated feature map Fₕ and a second operated feature map F_{w} of a same size as original input Csp_2_F, an attention weight g h in height and an attention weight g^{w} in width corresponding to the first operated feature map and the second operated feature map are obtained by an activation function, then the first operated feature map and the second operated feature map are performed full multiplication with the fish school feature map based on the attention weights to obtain the coordinate attention feature map y_{c}. The formulas are as follows.

g^{h}=∂(Fₕ(f^{h})) (4)

g^{w}=∂(F_{w}(f^{w})) (5)

y_{c}=x_{c}(i,j)·g_{c}^{h}(i)·g_{c}^{w}(j) (6)

A convolutional block attention module (CBAM) is added after Csp_4 layer of the backbone structure, a channel 512 of the input feature map (i.e., a transformed feature map obtained by transforming the coordinate attention feature map) Csp_4_F (20*20*512) is adopted different pooling operations such as global max pooling and global avg pooling to obtain two 1*1*512 richer high-level features (i.e., a first pooling feature map and a second feature map), then input into a multilayer perceptron (MLP) (a number of neurons in first layer is 1/16, and the number of neurons in second layer is 512) to obtain two weights, dual weights of channel and spatial are obtained by overlaying the two weights, and the channel attention feature map Csp_4_F1 is obtained based on the activation function and the dual weights of channel and spatial. The formula is as follows.

Csp_4_F1=δ(MLP(AvgPool(Csp_4_F))+MLP(MaxPool(Csp_4_F))) (7)

A result F2 bitwise multiplied by Csp_4_F1 and Csp_4_F (20*20*512) is input into the global max pooling and the global avg pooling based on the channel 512 to obtain two features (20*20*1) (i.e., a third pooling feature map and a fourth pooling feature map). Then, the two features are connected to obtain a connected feature map (20*20*2), and the spatiotemporal attention feature map Csp_4_F2 is obtained by a series of operations such as convolutional operation, activation function and bitwise multiplied with Csp_4_F (20*20*512). The formula is as follows.

Csp_4_F2=δ(f^{7×7}([AvgPool(F2);MaxPool(F)])) (8)

In conclusion, three effective feature maps Feature 1 (80*80*128) (the fish school feature map Csp_2_F), Feature 2 (40*40*256) (the coordinate attention feature map y c) and Feature 3 (20*20*512) (the spatiotemporal attention feature map Csp_4_F2) are output.

Transformation of the above features is merely as a specific embodiment to explain the disclosure, during actual use of the disclosure, sizes of the output images and the output feature maps can be adjusted according to actual needs, the disclosure does not define them.

The neck structure is configured to fuse features, it is path aggregation network, and the neck structure is configured to fuse the output feature maps of the coordinate attention mechanism and the spatiotemporal attention mechanism, all convolutional layers are convolution-batch normalization-sigmoid linear unit (CBS). Feature 1, Feature 2 and Feature 3 of the backbone part are performed feature fusion of up-sample and down-sample based on three different scales of feature information.

The head structure includes three 1*1 convolutional layers. In addition to the activation function of the attention mechanism module is H-S wish, the activation functions of other layers are Swish, convolutional composition is used to judge feature points whether there are objects corresponding to them.

According to the fish school detection method provided in the disclosure, after the determining a network structure of the fish school detection model, a sample fish school image set is determined by obtaining multiple sample fish school images and creating labels and the fish school detection model is trained. Network parameters of the fish school detection model are updated according to a cosine annealing method, and the fish school detection model is iteratively trained based on the updated network parameters until the fish school detection model converges.

The fish school detection model for identifying zebrafish fries is taken as an example, the sample fish school image set is determined by obtaining multiple sample fish school images and creating labels.

The zebrafish fries with 0.5-1.5 centimeters (cm) length are fed in a fishbowl, a mobile camera is used to capture images of fish schools every 5 seconds facing the fishbowl. Effective data is filtered and annotated by an annotating software, 692 experimental data are obtained by basic image processing methods such as rotating, flipping, and cropping, and there are 15081 fish fries in total, a random division ratio of a training set, a validation set, a test set is 8:1:1.

In the disclosure, a method for preprocessing sample images can be selected according to actual needs, the disclosure does not define it.

The sample fish school image set is determined, then basic parameters of the model are configured, the fish school detection model is trained by using the sample fish school image set. During training progress, the input images are normalized to 640*640*3, a positive sample matching process is fused into a data encapsulation process, a pre-training weight of a common objects in context (COCO) dataset is migrated, and weights of exponential moving average (EMA) regulation model are added. The backbone network is frozen and trained to 50 epochs, and batch_size is 16, then the backbone network is thawed and trained to 100 epochs, the batch_size is 8. Mosaic data augmentation is used during training, but it is turned off at 70^{th} epoch of thawing training. And an incentive factor r of CBAM is 16, and the incentive factor r of CA is 8.

A maximum learning rate of the model is 1 e-2, and a minimum learning rate is 0.01 times the maximum learning rate, learning rate decay is cosine annealing. The network parameters of the fish school detection model are updated based on a target loss function, and the fish school detection model is iteratively trained based on the updated network parameters until the fish school detection model converges, the selected optimal result is the fish school detection model.

A training method for the fish detection model based on the objective function and the loss function and conditions for stopping iterative training can be selected according to actual situation, the disclosure does not define them.

Model parameters of the fish school detection model for identifying the zebrafish fries is as follows.

| | | | Kernel | | Kernel | Activation |
|---|---|---|---|---|---|---|
| Network Layer | | Input | Size | Stride | Number | Function |
| Backbone | Input | 640*640*3 | 1*1 | 2 | 12 | Swish |
| | Focus | 320*320*12 | 3*3 | 1 | 32 | Swish |
| | CBS | 320*320*32 | 3*3 | 2 | 64 | Swish |
| | CBS | 160*160*64 | 3*3 | 1 | 64 | Swish |
| | Csp_1 | 160*160*64 | 1*1, 3*3 | 2 | 128 | Swish |
| | CBS | 80*80*128 | 3*3 | 1 | 128 | Swish |
| | Csp_2 | 80*80*128 | 1*1, 3*3 | 1 | 128 | Swish |
| | CA | 80*80*128 | 1*1 | 2 | 256 | H-Swish |
| | CBS | 40*40*256 | 3*3 | 1 | 256 | Swish |
| | Csp_3 | 40*40*256 | 1*1, 3*3 | 2 | 512 | Swish |
| | CBS | 20*20*512 | 3*3 | 1 | 512 | Swish |
| | SPP | 20*20*512 | 5*5, 9*9, 13*13 | 1 | 512 | Swish |
| | Csp_4 | 20*20*512 | 1*1, 3*3 | 1 | 512 | Swish |
| | CBAM | 20*20*512 | 1*1, 7*7 | 1 | 512 | H-Swish |
| Neck | CBS | 20*20*512 | 1*1 | 1 | 256 | Swish |
| | Upsample | 20*20*256 | 1*1 | 1 | 256 | Swish |
| | Concat + Csp | 40*40*256 | 1*1, 3*3 | 1 | 256 | Swish |
| | CBS | 40*40*256 | 1*1 | 1 | 128 | Swish |
| | Upsample | 40*40*128 | 1*1 | 1 | 128 | Swish |
| | Concat + Csp | 80*80*128 | 1*1, 3*3 | 1 | 128 | Swish |
| | Downsample | 80*80*128 | 3*3 | 2 | 128 | Swish |
| | Concat + Csp | 40*40*128 | 1*1, 3*3 | 1 | 256 | Swish |
| | Downsample | 40*40*256 | 3*3 | 2 | 512 | Swish |
| | Concat + Csp | 20*20*512 | 1*1, 3*3 | 1 | | Swish |
| Head | ConvLayer1 | 80*80*128 | 1*1 | 1 | 18 | Swish |
| | ConvLayer2 | 40*40*256 | 1*1 | 1 | 18 | Swish |
| | ConvLayer3 | 20*20*512 | 1*1 | 1 | 18 | Swish |

The above model training method is merely used as a specific embodiment to illustrate the disclosure. During actual use of the disclosure, types and amounts of model sample fish, as well as model parameters, can be adjusted according to actual needs, and the disclosure does not define them.

A structural schematic diagram of a fish school detection system provided in the disclosure is shown in FIG. 4, the disclosure provides a fish school detection system, includes an image input unit 401, a feature extraction unit 402, a feature fusion unit 403 and a feature recognition unit 404.

The image input unit 401 is configured to input a to-be-detected fish school image into a fish school detection model; and the fish school detection model includes: a feature extraction layer, a feature fusion layer and a feature recognition layer.

The feature extraction unit 402 is configured to extract feature information of the to-be-detected fish school image based on the feature extraction layer, and determine a fish school feature map and an attention feature map based on an attention mechanism.

The feature fusion unit 403 is configured to fuse the fish school feature map and the attention feature map based on the feature fusion layer to determine a target fusion feature map.

The feature recognition unit 404 is configured to determine a target fish school detection result based on the feature recognition layer and the target fusion feature map.

After the target to-be-detected fish school image is obtained, the image input unit 401 is configured to input the to-be-detected fish school image into the trained fish school detection model.

The feature extraction unit 402 is configured to extract the feature information of the to-be-detected fish school image to obtain the fish school feature map based on the feature extraction layer of the fish school detection model, and obtain the fish school attention feature map according to an attention mechanism.

The fish school feature map and the attention feature map are determined and then input into the feature fusion layer of the model. The feature fusion unit 403 is configured to fuse the fish school feature map and the attention feature map based on the feature fusion layer to determine a target fusion feature map.

The fused target fusion feature map is input into the feature recognition layer, the feature recognition unit 404 is configured to determine a target fish school detection result based on the feature recognition layer and the target fusion feature map.

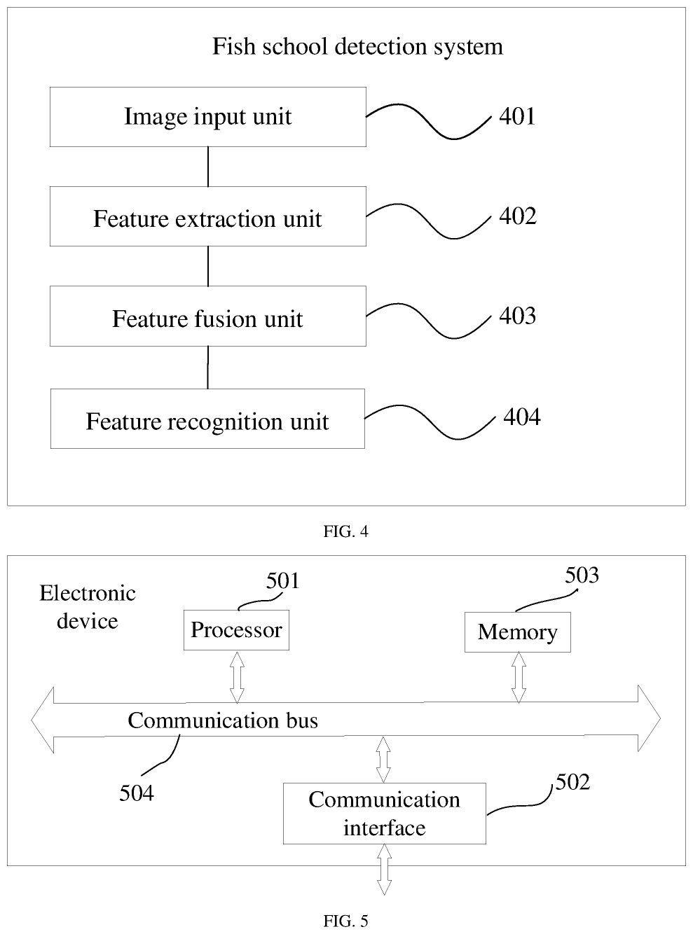

A structural schematic diagram of an entity of an electronic device provided in the disclosure is shown in FIG. 5, the electronic device can include: a processor 501, a communication interface 502, a memory 503 and a communication bus 504, the processor 501, the communication interface 502 and the memory 503 communicate with each other through the communication bus 504. The processor 501 can call logical instructions stored in the memory 503 to execute the fish school detection method.

Moreover, the above logical instructions of the memory 503 can be implemented by a form of software function unit, and the logical instructions can be stored in a computer readable storage medium when sold or used as an independent product. The technical solution of the disclosure, in essence, or parts of contributing to the related art or parts of the technical solution can be reflected in a form of software products, the computer software product is stored in a storage medium, and the computer software product includes multiple instructions to enable a computer device (which can be a personal computer, server, or network device, etc.) to perform all or part of the steps of each embodiment of the disclosure. The mentioned storage medium includes: various medium stored program code such as USB flash disk, mobile hard disk, read-only memory, random access memory, disk, light disk and the like.

The disclosure provides a computer program product, the computer program product includes computer program stored in a non-transitory computer readable storage medium, and includes program instructions, computer can execute the fish school detection method provided in the above methods when the program instructions are executed by computer.

Moreover, the disclosure provides a non-transient computer readable storage medium, it stores computer program, and the fish school detection method provided in the above methods is implemented when the computer program is executed by the processor.

The device embodiments described above are merely schematic, where units described as separate components can be or may not be physically separated, and the components displayed as units may be or may not be physical units, that is, they can be located in one place or distributed across multiple network units. Some or all modules can be selected according to actual needs to achieve purpose of the embodiments. Those skilled in the art can understand and implement without creative work.

Finally, it should be noted that: the above embodiments are merely used to illustrate the technical solution of the disclosure, not to limit it; although the disclosure has been described in detail concerning the aforementioned embodiments, those skilled in the art should understand: they can still modify the technical solutions recorded in the aforementioned embodiments, or equivalently replace some of the technical features; and these modifications or replacements do not separate the essence of the corresponding technical solutions from the spirit and scope of the various embodiments of the disclosure.

What is claimed is:

1. A fish school detection method, comprising:
inputting a to-be-detected fish school image into a fish school detection model; wherein the fish school detection model comprises: a feature extraction layer, a feature fusion layer and a feature recognition layer;
extracting feature information of the to-be-detected fish school image based on the feature extraction layer, and determining a fish school feature map and an attention feature map based on an attention mechanism;
fusing, based on the feature fusion layer, the fish school feature map and the attention feature map to determine a target fusion feature map; and
determining a target fish school detection result based on the feature recognition layer and the target fusion feature map.

2. The fish school detection method as claimed in claim 1, wherein the feature extraction layer comprises: an initial feature extraction layer and an attention feature extraction layer;
wherein the extracting feature information of the to-be-detected fish school image based on the feature extraction layer, and determining a fish school feature map and an attention feature map according to the attention mechanism, comprises:
extracting, based on the initial feature extraction layer, the feature information of the to-be-detected fish school image to determine the fish school feature map; and
transforming the fish school feature map to determine the attention feature map based on the attention feature extraction layer, a coordinate attention mechanism, a channel attention mechanism and a spatial attention mechanism.

3. The fish school detection method as claimed in claim 2, wherein the attention feature extraction layer comprises: a coordinate attention feature extraction layer and a convolutional block attention feature extraction layer; and the attention feature map comprises a coordinate attention feature map and a spatiotemporal attention feature map;
wherein the transforming the fish school feature map to determine the attention feature map based on the attention feature extraction layer, a coordinate attention mechanism, a channel attention mechanism and a spatial attention mechanism, comprises:
transforming, based on the coordinate attention feature extraction layer and the coordinate attention mechanism, the fish school feature map to determine the coordinate attention feature map; and
transforming, based on the convolutional block attention feature extraction layer and the channel attention mechanism, the fish school feature map to determine a channel attention feature map, and transforming, based on the spatial attention mechanism, the channel attention feature map to determine the spatiotemporal attention feature map.

4. The fish school detection method as claimed in claim 3, wherein the fusing, based on the feature fusion layer, the fish school feature map and the attention feature map to determine the target fusion feature map, comprises:
fusing, based on the feature fusion layer and a feature pyramid network, the fish school feature map, the coordinate attention feature map and the spatiotemporal attention feature map to determine the target fusion feature map at three different scales.

5. The fish school detection method as claimed in claim 1, wherein the determining a target fish school detection result based on the feature recognition layer and the target fusion feature map, comprises:
determining types and amounts of target fish in the to-be-detected fish school image based on the feature recognition layer and the target fusion feature map; and
determining the target fish school detection result by deleting duplicate detection values based on a non-maximum suppression algorithm.

6. The fish school detection method as claimed in claim 1, before the inputting a to-be-detected fish school image into the fish school detection model, comprising: determining a network structure of the fish school detection model;
wherein the determining a network structure of the fish school detection model, comprises:
embedding a coordinate attention module and a convolutional block attention module sequentially in a backbone feature extraction network based on a you only look once (YOLOv5s) algorithm network structure.

7. The fish school detection method as claimed in claim 6, after the determining a network structure of the fish school detection model, comprising: training the fish school detection model;
wherein the training the fish school detection model, comprises:
determining a sample fish school image set by obtaining a plurality of sample fish school images and creating labels;
training the fish school detection model based on the sample fish school image set; and
updating network parameters of the fish school detection model based on a target loss function and a cosine annealing method, and iteratively training the fish school detection model based on the updated network parameters until the fish school detection model converges.

8. The fish school detection method as claimed in claim 3, wherein the transforming, based on the coordinate attention feature extraction layer and the coordinate attention mechanism, the fish school feature map to determine the coordinate attention feature map, comprises:
performing a first set of transformations on the fish school feature map to obtain a transformed fish school feature map; and
performing a second set of transformations on the transformed fish school feature map to obtain the coordinate attention feature map.

9. The fish school detection method as claimed in claim 8, wherein the performing a first set of transformations on the fish school feature map to obtain a transformed fish school feature map, comprises:
performing global average pooling on the fish school feature map to obtain a first feature map;
performing one-dimensional feature encoding on the first feature map to obtain a second feature map and a third feature map;
connecting the second feature map and third feature map to obtain a connected feature map; and
transforming the connected feature map to obtain the transformed fish school feature map.

10. The fish school detection method as claimed in claim 8, wherein the performing a second set of transformations on the transformed fish school feature map to obtain the coordinate attention feature map, comprises:
performing segmentation on the transformed fish school feature map to obtain a fourth feature map and a fifth feature map;
performing a dimension elevation operation on the fourth feature map and the fifth feature map to obtain a first operated feature map and a second operated feature map;
obtaining attention weights corresponding to the first operated feature map and the second operated feature map; and
performed multiplication on the first operated feature map, the second operated feature map and the fish school feature map based on the attention weights to obtain the coordinate attention feature map.

11. The fish school detection method as claimed in claim 3, wherein the transforming, based on the convolutional block attention feature extraction layer and the channel attention mechanism, the fish school feature map to determine a channel attention feature map, comprises:
transforming the coordinate attention feature map to obtain a transformed feature map;
performing two pooling operations on the transformed feature map to obtain a first polling feature map and a second pooling feature map, and the two pooling operations being different;
obtaining two weights based on the first polling feature map and the second pooling feature map, and overlaying the two weights to obtain dual weights of channel and spatial; and
obtaining the channel attention feature map based on the dual weights and an activation function.

12. The fish school detection method as claimed in claim 11, wherein the transforming, based on the spatial attention mechanism, the channel attention feature map to determine the spatiotemporal attention feature map, comprises:
performing bitwise multiplication on the channel attention feature map and the transformed feature map to obtain a result;
performing the two pooling operations on the result to obtain a third pooling feature and a fourth pooling feature map;
connecting the third pooling feature and the fourth pooling feature map to obtain a connected feature map; and
obtaining spatiotemporal attention feature map based on the connected feature map.

13. A fish school detection system, comprising: an image input unit, a feature extraction unit, a feature fusion unit and a feature recognition unit;
wherein the image input unit is configured to input a to-be-detected fish school image into a fish school detection model; and the fish school detection model comprises: a feature extraction layer, a feature fusion layer and a feature recognition layer;
wherein the feature extraction unit is configured to extract feature information of the to-be-detected fish school image based on the feature extraction layer and determine a fish school feature map and an attention feature map;
wherein the feature fusion unit is configured to fuse, based on the feature fusion layer, the fish school feature map and the attention feature map to determine a target fusion feature map; and
wherein the feature recognition unit is configured to determine a target fish school detection result based on the feature recognition layer and the target fusion feature map.

14. An electronic device, comprising a processor, a memory and a communication bus, wherein the processor and the memory communicate with each other through the communication bus, the memory stores program instructions executable by the processor, and the processor is configured to call the program instructions to implement the fish school detection method as claimed in claim 1.

15. A non-transitory computer-readable storage medium, storing a computer program thereon, wherein the computer program is configured to be executed by a processor to implement the fish school detection method as claimed in claim 1.
